(19) United States
(12) Patent Application Publication
(10) Pub. No.: US 2015/0033709 A1
(43) Pub. Date: Feb. 5, 2015

(54) SULFUR SENSOR FOR ENGINE EXHAUST

(71) Applicant: General Electric Company, Schenectady, NY (US)

(72) Inventors: Daniel George Norton, Niskayuna, NY (US); William Collins Vining, Schenectady, NY (US); Dennis John Spaulding, Waukesha, WI (US)

(73) Assignee: General Electric Company, Schenectady, NY (US)

(21) Appl. No.: 13/955,254

(22) Filed: Jul. 31, 2013

(51) Int. Cl. F01N 13/00; G01M 15/10

(52) U.S. Cl. CPC F01N 13/008; G01M 15/102
USPC 60/276; 73/23.31

(57) ABSTRACT

A system and a method of operating the system are presented. The system includes a first sensor, a second sensor and a catalyst. The catalyst is located between the first sensor and the second sensor in the path of an exhaust stream from an engine. The first sensor and the second sensors include noble metal electrodes, and are configured to measure concentration of a gaseous species and produce first and second sensor signals respectively. The system further includes a sulfur detector that is configured to receive the first and second signals, and configured to determine a sulfur concentration in the exhaust stream with a lambda value less than 1. The sulfur detector is configured to detect the concentration of sulfur by performing a calculation involving the first and second sensor signals; and by producing an output signal based on the determined sulfur concentration.

### BACKGROUND

The invention relates generally to a sulfur sensor and in particular to a sulfur sensor based on the output of multiple gas sensors.

Sulfur is normally present in fossil fuels in a range from about 0.1% to about 10% depending on the place of origin and processing of the fossil fuels.

Exhaust streams generated by the combustion of fossil fuels in, for example, furnaces, ovens, and engines, contain SO₂ due to the oxidation of sulfur present in fossil fuel, which together with exhaust gas is released to the atmosphere where it can be subject to other reactions contributing to smog and acid rains.

Fuels containing sulfur lead to further disadvantages when trying to clean-up the exhaust gases by some form of catalytic after-treatment. SO₂ poisons some catalysts. Further poisoning happens from the formation of base metal sulphates from the components of catalyst compositions. These sulphates can act as a reservoir for poisoning sulfur species within the catalyst.

Therefore, there is a need for real-time determination of the amount of sulfur present in the exhaust gas stream. This knowledge can enable control and operating improvements to engines and after treatment systems to meet emission specifications.

### BRIEF DESCRIPTION

In one embodiment, a system is presented. The system includes a first sensor, a second sensor and a catalyst. The catalyst is located between the first sensor and the second sensor in the path of an exhaust stream from an engine. The first sensor and the second sensors include noble metal electrodes, and are configured to measure concentration of a gaseous species and produce first and second sensor signals respectively. The system further includes a sulfur detector that is configured to receive the first and second signals, and to determine a sulfur concentration in the exhaust stream during a steady state operation of the system. The steady state operation used herein is with a lambda value less than 1. The sulfur detector is configured to detect the concentration of sulfur by performing a calculation involving the first and second sensor signals; and by producing an output signal based on the determined sulfur concentration.

In one embodiment, a method of determining a sulfur concentration of an exhaust stream during a steady state operation of the system with lambda value less than 1 is provided. The method includes positioning a catalyst in a path of an exhaust stream of an engine, positioning a first gas sensor upstream of the catalyst, and positioning a second gas sensor downstream of the catalyst. The first and second sensors have noble metal electrodes. During the steady state operation with lambda less than 1, the first sensor produces a first sensor signal indicative of concentration of a gaseous species, and the second sensor produces a second signal indicative of concentration of the same gaseous species. The sulfur concentration in the exhaust stream is determined using a calculation involving the first and second sensor signals.

### BRIEF DESCRIPTION OF DRAWINGS

FIG. 1 is a schematic diagram of a system in accordance with one embodiment of the invention; and

FIG. 2 is a graphical comparison of the first and second sensor outputs and the differences between the first and second sensor outputs in the absence and presence of sulfur in the exhaust stream, in accordance with one embodiment of the invention.

### DETAILED DESCRIPTION

The systems and methods described herein include embodiments that relate to a system comprising internal combustion engines and emission from the engines. Suitable combustion devices may include furnaces, ovens, or engines.

In the following specification and the claims that follow, the singular forms “a”, “an” and “the” include plural referents unless the context clearly dictates otherwise.

As used herein, a catalyst is a substance that can cause a change in the rate of a chemical reaction. The catalyst may participate in the reaction and get regenerated at the end of the reaction.

As used herein, the term “adjacent,” when used in context of discussion of different components comprising the gas sensor refers to “immediately next to” or it refers to the situation wherein other components are present between the components under discussion.

As used herein, the term “communication,” when used in context of discussion of more than one component comprising the gas sensor may mean that any change in an electrical characteristic of one component is reflected at, and therefore, detectable and measurable via, the other component.

A gas sensor can be any device capable of producing an electrical signal proportional to a response characteristic that can be modulated upon exposure to gases. Examples of suitable devices include, but are not limited to, a resistor, a field effect transistor, a capacitor, a diode, and a combination thereof.

Examples of suitable gases to be sensed include, but are not limited to, NO, NO₂, SOₓ, O₂, H₂O, NH₃, CO, and combinations thereof.

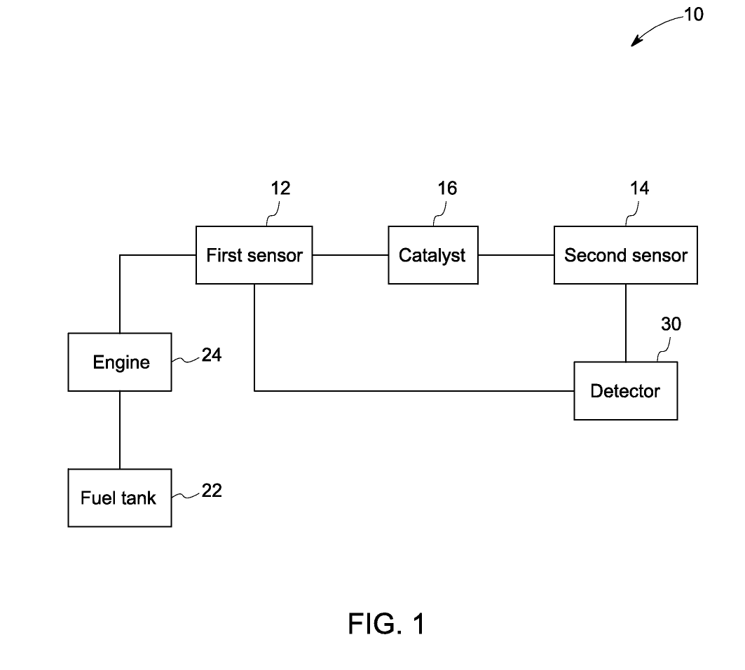

Referring to the drawings in general and to FIG. 1 in particular, it will be understood that the illustrations are for the purpose of describing a preferred embodiment of the invention and are not intended to limit the invention thereto.

FIG. 1 is a diagrammatical representation of a system 10. The system includes a first sensor 12, a second sensor 14, and a catalyst 16. The system 10 optionally may further include a fuel tank 22 adapted to supply a fuel, and a combustion engine 24 configured to receive the fuel and create an exhaust stream.

A fuel tank 22 is a storage place for fuel or a continuous supply of fuel. Fuel may be of different kinds that are used to run the combustion engines. In one embodiment, fuel comprises a material selected from the group consisting of diesel fuel, ultra-low sulfur diesel (ULSD), biodiesel fuel, Fischer-Tropsch fuel, gasoline, ethanol, kerosene, and any combination thereof. In a further embodiment, the fuel comprises diesel fuel or biodiesel fuel.

A combustion engine 24 is any engine that accepts fuel, performs an action by burning fuel and emits an exhaust stream. In one embodiment, the combustion engine is an internal combustion engine in which the combustion of a fuel occurs with an oxidizer in a combustion chamber resulting in an expansion of the high temperature and pressure gases that can be applied to move a movable component of the engine. Examples of combustion engines include gasoline engines, diesel engines, and gas turbines.

An emission treatment system reduces harmful emissions in an exhaust stream. At least a portion of the fuel is burned in an engine during operation of the engine and an emission of exhaust gases is produced thereby. In one embodiment, the emission treatment system is configured to receive at least a portion of the exhaust stream. The exhaust gases, thus produced, are discharged to the catalyst of an emission treatment system, where the emission is treated.

Sensors 12, 14 may be used to determine if an analyte is present or to quantify an amount of the analyte. As used herein, the term “analyte” refers to any substance to be detected or quantified, including but not limited to a gas, a vapor, a bioanalyte, particulate matter, and a combination thereof.

In one embodiment, the sensors 12 and 14 are gas sensors. Although oxygen is used as an example with respect to some of the embodiments of the gas sensors described herein, it is to be understood that the gas sensor may be useful to detect other analytes, such as, for example, NOx, H₂O, CO, SOₓ, NH₃, or any combinations thereof. The gas sensors 12, 14 might be, for example, an in-situ gas sensor that directly samples a gas stream to be analyzed. In this way, the gas sensors 12, 14 may be exposed to the gas stream and generate a detection signal indicating whether a particular analyte (e.g., oxygen) is present. The gas sensors 12, 14 may further generate a signal proportional to the concentration of the analyte and thereby aid measuring concentration of the analyte. The gas sensors 12, 14 may include lambda sensors. In one embodiment, the gas sensors 12, 14 are lambda sensors. The lambda sensors may contain a solid state electrochemical cell and have an oxygen permeable membrane with electrodes. The electrodes of lambda sensors include a noble metal.

In one embodiment, sensors 12, 14 used herein are in the form of a thin film or a thick film over a support. As used herein, the term “thin film,” when used in the context of discussion of the gas sensing layer of a gas sensor refers to the situation wherein the thickness of the said gas sensing layer is from about 10 nm to about 500 nm.

As used herein, the term “thick film,” when used in the context of discussion of the gas sensing layer of a gas sensor refers to the situation wherein the thickness of the said gas sensing layer is from about 500 nm to about 500 μm.

The support on which the thin film or thick film is deposited may be composed of ceramics such as, for example, alumina, zirconia, or yttria stabilized zirconia (YSZ).

The catalyst 16 employed herein may vary depending on the type of fuel and the process of burning the fuel. In one embodiment, the catalyst 16 used herein is a water gas shift catalyst. In one embodiment, the catalyst 16 used herein is a three-way catalyst. A three-way catalyst is able to convert three main pollutants in an exhaust, such as, for example, an automobile emission from petrol engines. The three main pollutants identified in the automobile industry are carbon monoxide, unburned hydrocarbon, and nitrogen oxides. A three-way catalyst oxidizes CO to CO₂, HC to water and CO₂ and reduces NOx to nitrogen.

Three-way catalysts normally use a substrate and an active coating. The substrate and the active coatings may be made from different ceramic or metallic materials. In one embodiment, a ceramic substrate is used with an active coating incorporating a combination of ceramic and precious metals such as platinum, palladium, or rhodium. Suitable catalyst metal may include one or more of indium, rhodium, palladium, ruthenium, iridium, platinum, gold, and silver.

Generally three-way catalysts operate in a closed-loop system constantly regulating an air-fuel ratio on the engines. An air-fuel ratio is the mass ratio of air to fuel present in a combustion engine at the time of combustion. In a stoichiometric air-fuel mixture, exactly enough amount of air is provided to completely burn all of the fuel. For example, a stoichiometric air-fuel mixture ratio for gasoline fuel is approximately about 14.7:1, which may vary depending on the exact composition of the gasoline fuel. If the air-fuel ratio is lesser than this, the mixture is considered as a “rich” mixture, and if the ratio is more than 14.7:1, then the mixture is considered as a “lean” mixture.

A lambda (λ) sensor measures an air-fuel equivalence ratio, which is the ratio of actual air-fuel ratio to stoichiometric air-fuel ratio for a given mixture. A mixture with λ=1.0 is considered as the stoichiometric mixture, λ<1.0 is considered as a rich mixture, and λ>1.0 is considered as a lean mixture. Since the composition of common fuels may vary seasonally, or by location, a λ value is hereby used rather than the air-fuel ratio. Hence, in one embodiment, the sensors 12 and 14 are lambda sensors. The lambda sensors may be used to regulate the air-fuel ratio at the combustion engine 24.

In one embodiment, the first sensor 12 is located upstream of the catalyst 16 and the second sensor 14 is located downstream of the catalyst 16, as shown in FIG. 1. The “upstream” and “downstream” as used herein are with respect to the travel path of the exhaust stream from the combustion engine 24. Hence a sensor 12 that is located upstream of the catalyst 16 gets exposed to the exhaust stream before the catalyst 16, and the second sensor 14. The sensor 14 that is located downstream of the catalyst 16 gets exposed to the exhaust stream after that exhaust stream passes over the first sensor 12 and the catalyst 16. In one embodiment, the sensor 12 that is upstream of catalyst 16 is termed as “pre-catalyst” sensor 12, and the sensor 14 that is downstream of the catalyst 16 is termed as “post-catalyst” sensor 14. The sensors 12 and 14 may be positioned adjacent to the catalyst 16. In one embodiment, there are no other intervening sensor or catalysts in between the pre-catalyst sensor 12, catalyst 16, and the post-catalyst sensor 14. Thus, in this embodiment, the catalyst 16 directly encounters the exhaust stream that passed over the pre-catalyst sensor 12, and the post-catalyst sensor 14 directly meets the exhaust stream that has passed over the catalyst 16, without undergoing any further reaction with any other components of the system 10.

When the exhaust stream from the combustion engine 24 passes through the first sensor 12, and the second sensor 14, the sensors 12 and 14 generate signals corresponding to the gaseous species that is detected by them. For example, if the sensors 12 and 14 are oxygen sensors, the sensors 12 and 14 may send signals that may be indicative of the presence and concentration of the oxygen in the exhaust stream. These signals from the sensors 12 and 14 may be detected by a sulfur detector 30 that may be a part of the system 10.

In one example experiment, it was observed by the inventors that the pre-catalyst gas sensor 12 and the post catalyst gas sensor 14 normally show the same value for the concentration of the gas species when the combustion engine 24 was run in the “lean-burn” condition (λ>1) and the exhaust stream from the engine 24 was passed on a three-way catalyst 16 after passing through the sensor 12 and before passing through the sensor 14. This was observed regardless of the absence or presence of sulfur contamination in the exhaust stream.

In a related example experiment, it was observed that, when there is no sulfur contamination present in the exhaust stream from the combustion engine 24, the pre-catalyst gas sensor 12 and the post catalyst gas sensor 14 normally show the same value for the concentration of the gas species when the combustion engine 24 was run in the “rich-burn” condition (λ<1) and the exhaust stream from the engine 24 was passed on a three-way catalyst 16 after passing through the sensor 12 and before passing through the sensor 14.

However, it was clearly observed that, when the exhaust stream from the combustion engine was contaminated with sulfur, the pre-catalyst gas sensor 12 and the post catalyst gas sensor 14 showed different values for the concentration of the gas species when the combustion engine 24 was run in the “rich-burn” condition (λ<1) and the exhaust stream from the engine 24 was passed on a three-way catalyst 16 after passing through the sensor 12 and before passing through the sensor 14. Further, the difference in the values of the pre-catalyst and post-catalyst gas sensors reading was found to vary with sulfur concentration in the exhaust. This difference in reading of the pre-catalyst sensor 12 and the post-catalyst sensor 14 may be used to arrive at the exact sulfur concentration in the exhaust stream. In one embodiment of the invention, the sulfur concentration of the exhaust stream is calculated as a function of difference between the signals of the first and second sensors.

The “sulfur” as used herein is not limited to the elemental sulfur, but includes the compounds of sulfur, such as for example, SO₂. The sulfur detector 30 as used herein need not be a direct gas detector measuring the presence and concentration of sulfur directly from the exhaust gas, but may be a computer, an analyzer, or any such component that is capable of receiving output signals from the sensors 12 and 14 and comparing or computing these signals to find concentration of sulfur in the exhaust stream of the system 10. The location of the sulfur detector 30 may not be significant here as far as the sulfur detector is able to receive output signals from sensors 12 and 14 without any signal loss.

The sulfur detector 30 as used herein is configured to receive the first and second signals from the sensors 12 and 14 respectively and determine a sulfur concentration in an exhaust stream during a steady state operation of the system with lambda value less than 1. The system does not need to be cycled between rich and lean states in order to measure sulfur concentration, nor does it need to be operated at a lambda value less than 1 at all times, but the signal to noise ratio of the sulfur detector 30 improves as the lambda value decreases below 1. As a result, measurement of the sulfur concentration occurs when the instantaneous lambda is less than 1.

At this condition, the sulfur detector 30 takes the inputs from the signals of the first sensor 12 and the second sensor 14, and by performing a calculation involving the first and second sensor signals, produces an output signal related to the determined sulfur concentration in the exhaust stream. Hence the sulfur detector used herein is capable of receiving the output signals generated from the first sensor 12 and the second sensor 14, when the sensors 12 and 14 received the exhaust stream that is generated by a combustion of a rich mixture continuously. In one embodiment of the invention, the system 10 is operated using a rich mixture with that lambda value maintained at a value less than about 0.997 at a steady state operation.

The output of the sulfur detector 30 indicating the concentration of sulfur present in the exhaust stream may be used in various ways to reduce the overall sulfur emission of the system. In one embodiment, the system 10 includes a control system (not shown) configured to receive the output signal from the sulfur detector 30 and alter an operation of the combustion engine so that the overall emission of sulfur is reduced.

### Example

The following example illustrates methods, materials and results, in accordance with specific embodiments, and as such should not be construed as imposing limitations upon the claims. All components are commercially available from common suppliers.

A wide-band lambda sensor 12 was placed in the path of a gaseous stream as shown in FIG. 1. A three-way catalyst 16 was positioned downstream of the sensor 12 and another wide-band lambda sensor 14 was positioned further down stream from the catalyst 16. The sensors 12 and 14 included platinum-rhodium electrodes and were configured to detect oxygen and measure the lambda values. The three-way catalyst 16 was stored in a quartz reactor tube, and was maintained at about 550° C. during the tests. A gas mixture having some gases selected from N₂, CO₂, H₂O, CO, NO, H₂, O₂, CH₄, and SO₂ was passed over the first wide-band lambda sensor 12, then through the three-way catalyst 16 and over the second wide-band sensor 14. The gas mixture was chosen to represent the exhaust of a rich-burn natural gas engine operating at a lambda value less than 0.997.

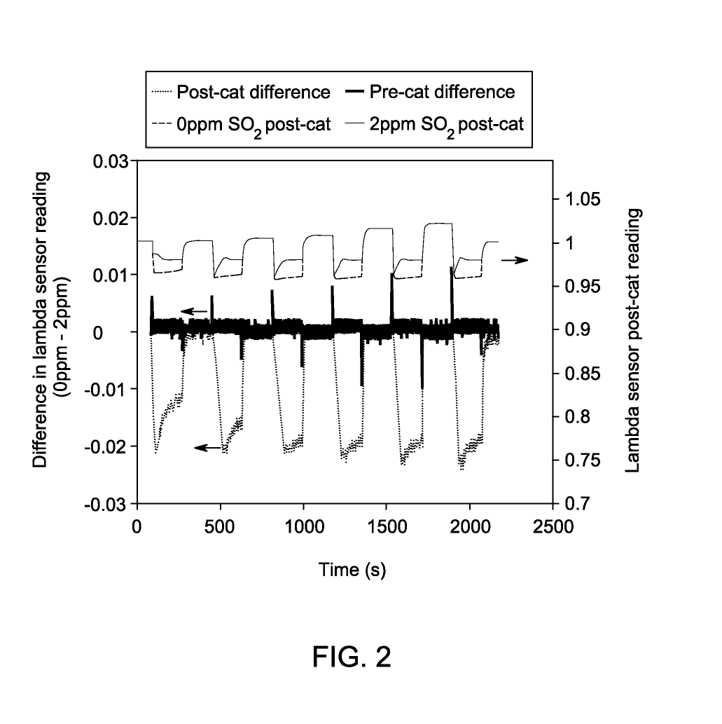

The lambda value was cycled between lean and rich states, maintaining each state for 3 minutes. The lambda values of the lean conditions were sequentially increased during each cycle. The test was run with and without 2 ppm SO₂, and the gas stream was passed over the sensors 12, and the catalyst 16, and the sensor 14. The left Y axis of FIG. 2 depicts the difference in sensor values with and without 2 ppm SO₂ for the pre-catalyst sensor 12 and post-catalyst sensor 14. The output data of the pre-catalyst sensor 12 and the post-catalyst sensor 14 as read from the right side Y axis were aligned to match changes in lambda values. Sulfur has an insignificant effect on the pre-catalyst sensor 12. However, a significant difference is measured by post-catalyst sensor 14 with and without 2 ppm SO₂ at the rich conditions. This graph demonstrates that when a rich gas mixture is passed over the catalyst, as seen by the post-catalyst lambda sensor reading less than 1, an offset occurs between the pre- and post-catalyst lambda sensors that changes with the presence of sulfur dioxide.

The offset in sensor output values changes with sulfur concentrations. Under rich conditions, forward water-gas-shift reaction over the catalyst becomes more pronounced, which consumes carbon monoxide and water and produces carbon dioxide and hydrogen. Since the oxygen sensor is more sensitive to hydrogen than carbon monoxide, the apparent lambda as measured by the post-catalyst sensor is smaller, i.e., richer, than for the pre-catalyst lambda sensor reading. When sulfur is present in the gas stream, the forward water-gas-shift reaction is hindered and less hydrogen is produced. Thus, the post catalyst oxygen sensor in the presence of sulfur will measure a value more similar to the pre-catalyst oxygen sensor reading than in a similar gas mixture without sulfur.

The initial difference in post-catalyst sensor readings with and without 2 ppm SO₂ when transitioning between lean and rich states is affected by the previous lean lambda state seen by the catalyst. The sulfur detector 30 may incorporate the history of the catalyst to account for this effect. However, transition from lean to rich states is not required to measure the sulfur concentration. The offset observed between the sensors 12 and 14 is also a function of lambda. The sulfur detector 30 may use this effect when predicting the sulfur concentration.

The embodiments described herein are examples of composition, system, and methods having elements corresponding to the elements of the invention recited in the claims. This written description may enable those of ordinary skill in the art to make and use embodiments having alternative elements that likewise correspond to the elements of the invention recited in the claims. The scope of the invention thus includes composition, system and methods that do not differ from the literal language of the claims, and further includes other compositions and articles with insubstantial differences from the literal language of the claims. While only certain features and embodiments have been illustrated and described herein, many modifications and changes may occur to one of ordinary skill in the relevant art. The appended claims cover all such modifications and changes.

1. A system, comprising:
a first sensor comprising a noble metal electrode, located upstream of a catalyst, and capable of producing a first sensor signal indicative of concentration of a gaseous species;
a second sensor comprising a noble metal electrode, located downstream of the catalyst, and capable of producing a second sensor signal indicative of concentration of the gaseous species; and
a sulfur detector configured to
receive the first and second signals;
determine a sulfur concentration in an exhaust stream with lambda value less than 1, by performing a calculation involving the first and second sensor signals; and
to produce an output signal based on the determined sulfur concentration.

2. The system of claim 1, wherein the first and second sensors are lambda sensors.

3. The system of claim 1, wherein the first and second sensors are oxygen sensors.

4. The system of claim 1, further comprising a combustion engine configured to emit the exhaust stream.

5. The system of claim 4, further comprising a control system configured to receive the output signal from the sulfur detector and alter an operation of the combustion engine.

6. A method, comprising:
producing a first sensor signal indicative of concentration of a gaseous species, from a first sensor comprising a noble metal electrode and positioned upstream of a three-way catalyst;
producing a second sensor signal indicative of concentration of the gaseous species, from a second sensor comprising a noble metal electrode, and positioned downstream of the three-way catalyst; and
determining a sulfur concentration of an engine exhaust stream with a lambda value less than 1, using a calculation involving the first and second sensor signals.

7. The method of claim 6, wherein the first and second sensors are lambda sensors.

8. The method of claim 6, wherein the first and second sensors are oxygen sensors.

9. The method of claim 6, further comprising passing the exhaust stream sequentially over the first sensor, the catalyst, and the second sensor.

10. The method of claim 6, wherein determining the sulfur concentration comprises calculating the sulfur concentration as a function of a difference between the signals of the first and second sensors.
